(19) United States
(12) Patent Application Publication
(10) Pub. No.: US 2011/0199195 A1
(43) Pub. Date: Aug. 18, 2011

(54) POWER LINE COMMUNICATION SYSTEM BASED ON CONSTANT CURRENT SOURCE

(75) Inventor: Young Gyu YU, Seoul (KR)

(73) Assignee: LS INDUSTRIAL SYSTEMS CO., LTD.

(21) Appl. No.: 13/028,167

(22) Filed: Feb. 15, 2011

(30) Foreign Application Priority Data
Feb. 18, 2010 (KR) 10-2010-0014594

(51) Int. Cl. G05B 11/01

(52) U.S. Cl. 340/12.32

(57) ABSTRACT

Disclosed herein is a power line communication system in which multiple loads are connected in series to constant current source, each individual equipment connected through an insulation transformer to a power line forming a closed loop has a current/voltage conversion part and a voltage/current conversion part, wherein a voltage signal towards the power line is converted and transmitted to a current signal, and a current signal received from the power line is converted and inputted to a voltage signal, and a communication performance lowered problem observable when using a voltage-type can be solved by performing a current-type power line communication and particularly, applied to an airfield lighting system in which multiple lamps are serially connected to a constant current-flowing single closed-loop, thereby performing a power line communication more stably for control of an airfield lighting lamp.

Pursuant to 35 U.S.C. §119(a), this application claims the benefit of earlier filing date and right of priority to Korean Application No. 10-2010-0014594, filed on Feb. 18, 2010, the contents of which are hereby incorporated by reference herein in their entirety.

### BACKGROUND OF THE DISCLOSURE

1. Field of the Disclosure

The present disclosure relates to a constant current based power line communication system, particularly to addressing a communication signal attenuation drawback resulting from a voltage division in a system required of driving serially connected multiple loads such as an airfield (approach) lighting system controlling lamps using a constant current to stably perform a power line communication.

2. Description of the Related Art

Due to advantage of using an existing power line without additional installation of a communication line, a power line communication is regarded as an adequate communication method for an airfield lighting system, a home network system, a remote inspection system, and a factory automation system that need control and monitor a multiple of lamps.

However, a prior-art power line communication using a voltage signal involves attenuation of a communication signal depending on the number of loads serially-connected to the power line, resulting in difficulty in conducting a smooth communication.

As a specific example, a wired communication is preferred by an airfield lighting field to prevent occurrence of interference of radio communication between pilots and control tower. Airports are applied with power line communication for individual lamp control and monitor of airfield lighting due to difficulty in installation of a new line.

An electric source in an airfield lighting is a constant current source having a single loop, and from a constant current regulator producing a constant current source to a final end lamp of a runway is installed a multiple of lamps attaining several tens to several hundreds of lamps, such that a line length reaches several kms to several tens kms.

A constant current generated by a constant current regulator flows onto a power line to form a closed loop, and the power line is serially connected to a multiple of individual lamp drivers connected through an insulation transformer to control an individual lamp.

Referring to an equivalent circuit of FIG. 1, a power line communication voltage signal Vᵢ is applied to a single loop serially connected to an electric line impedance, an impedance corresponding to an insulation transformer, and an impedance corresponding to a constant current regulator.

The power line communication voltage signal is attenuated through multiple insulation transformers, because voltages are divided by each impedance.

That is, a communication signal Vₒᵤₜ applied to the Mth insulation transformer can be expressed by the following Equation 1.

$${V}_{out} = \frac{{Z}_{M}}{{Z}_{eq}} \times {V}_{i} \\ {Z}_{eq} = ( {Z}_{L 1} + {Z}_{L 2} + … + {Z}_{LK} ) + ( {Z}_{T 1} + {Z}_{T 2} + … + {Z}_{TK} ) + {Z}_{c} , 1 \leq M \leq K \qquad [ Equation 1 ]$$

where, Z_{M} is an impedance corresponding to Mth insulation transformer, Z_{LK} is an electric line impedance of Kth duration, Z_{TK} is an impedance corresponding to Kth insulation transformer, and Z_{C} is an impedance corresponding to a constant current regulator.

As shown in Eq. 1, as K increases, Vₒᵤₜ decreases, and when Vₒᵤₜ is smaller than a signal level receivable by a power line communication modem, the corresponding power line communication modem does not operate.

That is, a system configuration of a voltage-type power line communication becomes hard, due to the fact that a power line communication signal received via each insulation transformer becomes smaller.

### SUMMARY OF THE DISCLOSURE

The present disclosure provides to solve the above-indicated problems, and it is an object of the present disclosure to provide a power line communication system capable of addressing signal attenuation caused by voltage division that may be generated by a voltage-type power line communication, by performing a current-type communication in a power line communication environment using a constant current such as airfield lighting system.

To achieve the above-described object, a constant current-based power line communication system according to the present disclosure is such that a power line flowing with a constant current forms a closed loop, wherein the power line is serially connected with a plurality of individual equipment. The each individual equipment is connected to the power line through an insulation transformer to operate using a constant current and a power line communication signal.

The each individual equipment includes a power line communication modem for transceiving a power line communication signal formed of a voltage signal; a voltage/current conversion part for converting the power line communication signal formed of a voltage signal transmitted by the power line communication modem to a current signal and applying the current signal to the insulation transformer; and a current/voltage conversion part for converting the power line communication signal formed of a current signal received through the insulation transformer to a voltage signal and delivering the voltage signal to the power line communication modem.

The voltage/current conversion part may be constructed to output a current signal in proportion to a pertinent voltage signal, when a voltage signal is applied to a non-inverting input terminal of an operational amplifier.

The current/voltage conversion part may be constructed to output a voltage signal in proportion to a pertinent current signal, when a current signal is applied to an inverting input terminal of an operational amplifier.

The each individual equipment may include an individual lamp driver configured to control an airfield lighting lamp according to a lamp control command delivered via a power line communication signal.

The individual lamp driver may include a power line coupler for coupling with a pertinent insulation transformer; a power supply circuit connected in parallel to the power line coupler, and generating a pre-determined power from a constant current flowing to a secondary side of the insulation transformer; and a control part operating by the power generated by the power supply circuit, thereby performing a power line communication with an upper-level device through a pertinent power line communication modem and controlling one or more airfield lighting lamps.

At this time, the power line coupler may be connected in series to a capacitor for blocking a constant current signal.

The power line communication system based on constant current source according to the present disclosure has an advantageous effect in that each input and output of a power line communication modem is provided with a current/voltage conversion part and a voltage/current conversion part, whereby a current-type power line communication is performed to solve a communication performance lowered problem observable when using a voltage type.

Particularly, the system can be applied to an airfield lighting system in which multiple lamps (loads) should be connected in series to a constant current-flowing single closed-loop, thereby performing a power-line communication more stably for control of an airfield lighting lamp.

### BRIEF DESCRIPTION OF THE DRAWINGS

FIG. 1 is an equivalent circuit of a voltage-type power line communication system according to prior-art;

FIG. 2, including FIG. 2a and FIG. 2b, is an embodiment of individual equipment constructing a constant current based power-line communication system according to the present disclosure;

FIG. 3 is an embodiment of a voltage/current conversion part;

FIG. 4 is an embodiment of a current/voltage conversion part;

FIG. 5 is an example of a power line communication system for airfield lighting;

FIG. 6 is an embodiment of an individual lamp driver used in a power line communication system according to the present disclosure; and

FIG. 7 is an example of an equivalent circuit for an alternating current interface of an individual lamp driver.

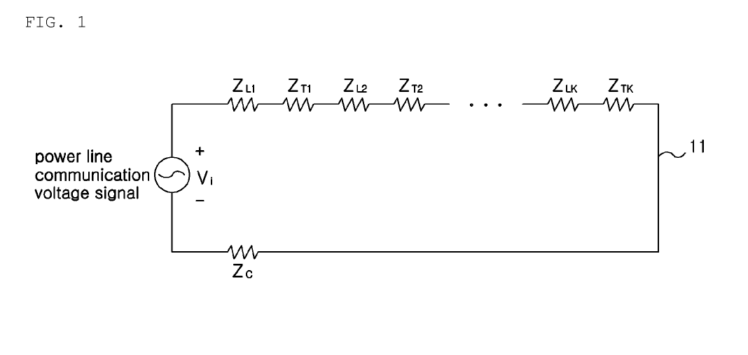

### DETAILED DESCRIPTION OF THE DISCLOSURE

Hereinafter, a preferred embodiment of the disclosure will be described in detail with reference to the accompanying drawings.

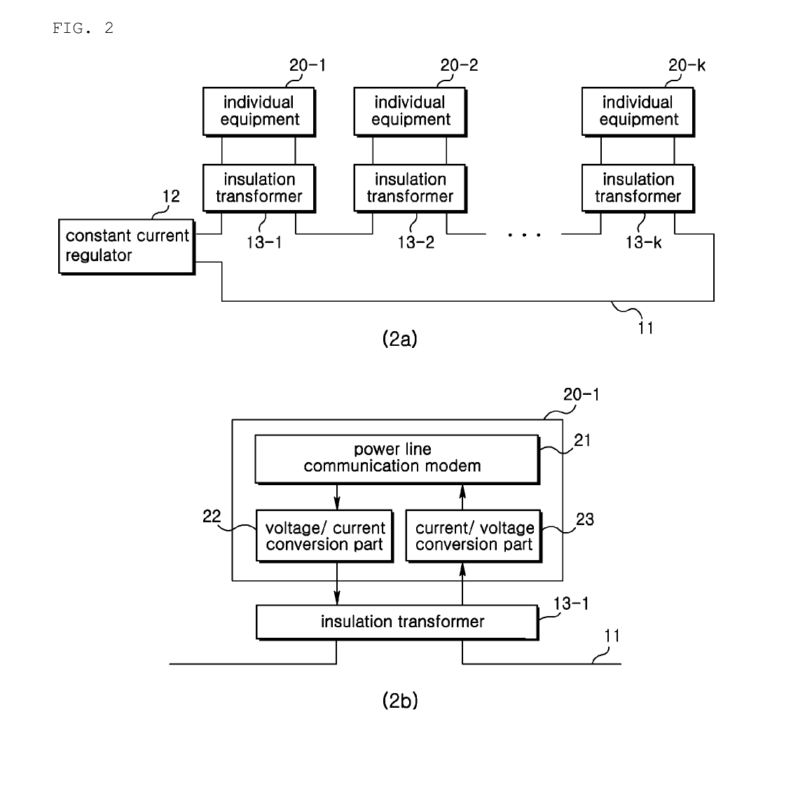

Referring to FIG. 2a, a constant current based power line communication system forms a closed loop by a power line 11 flowing with a constant current, in which the power line 11 is connected in series to a plurality of insulation transformers 13-1˜13-k.

Each individual equipment 20-1˜20-k is connected to a power line 11 via insulation transformers 13-1˜13-k to operate using constant current and a power line communication signal flowing at the power line 11.

As a function performed by each individual equipment 20-1˜20-k can be variously constructed as necessary, it is not necessary to conduct identical functions. That is, each individual equipment 20-1˜20-k includes constituent elements like FIG. 2b, but each can perform separate functions.

The power line 11 is connected with a constant current regulator 12, herein, the constant current regulator 12 refers to a device prescribed to supply a constant current to the power line 11.

Referring to FIG. 2b, each individual equipment includes a power line communication modem 21, a voltage/current conversion part 22, and a current/voltage conversion part 23.

A power line communication modem 21, as generally appreciated, performs a modulation and demodulation function of a power line communication signal in a voltage signal form so that the individual equipment may transceive any information through a power line communication mode.

The voltage/current conversion part 22 converts a power line communication signal formed of a voltage signal that is transmitted by the power line communication modem 21 transmits toward the power line 11 side, to a current signal, and applies the current signal to the insulation transformer 13-1.

A method of converting a voltage signal to a current signal may be variously constructed.

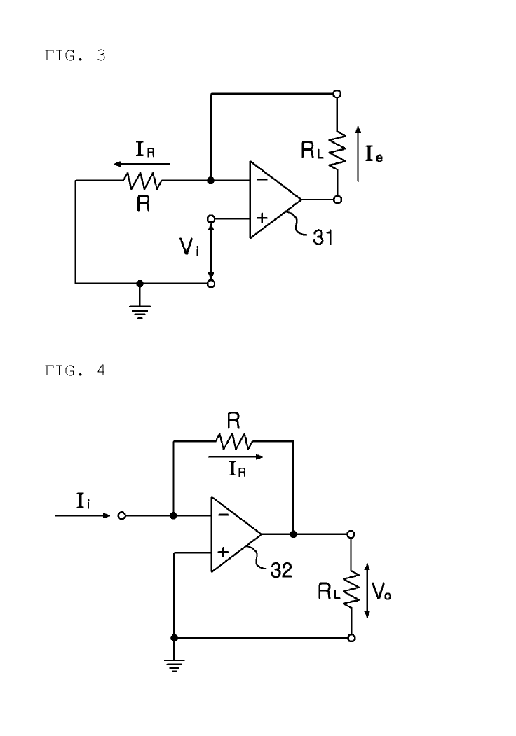

As an example, an operational amplifier 31 as shown in FIG. 3 can be used. The operational amplifier 31 is constructed to output a current signal proportional to a voltage signal applied to an non-inverting input terminal.

That is, a voltage signal Vᵢ is applied to a non-inverting input terminal of the operational amplifier 31, a resistor R is connected between an inverting input terminal and a ground, and a resistor R_{L} is connected between an inverting input terminal and an output terminal of the operational amplifier 31.

Then, due to characteristics of the operational amplifier 31, a current signal I₀ flowing through the resistor R_{L} has ‘Vᵢ/R’ level, proportional to a voltage signal Vᵢ.

The current/voltage conversion part 23 converts a power line communication signal formed of a current signal received from the power line 11 side via an insulation transformer 13-1 to a voltage signal thus to deliver the voltage signal to the power line communication modem 21.

A method of converting a current signal to a voltage signal may be variously configured.

As one example, an operational amplifier 32 as illustrated in FIG. 4 can be used. The operational amplifier 32 can be constructed to output a voltage signal proportional to a current signal applied to an inverting input terminal.

That is, an input current signal Iᵢ is applied to an inverting input terminal of the operational amplifier 32, a resistor R is connected between an inverting input terminal and an output terminal of the operational amplifier 32, and the non-inverting input terminal of the operational amplifier 32 is earthed.

Then, due to characteristics of an operational amplifier, a current signal Iᵢ flows through a resistor R, and an output terminal voltage signal V₀ has ‘−R*Iᵢ’ level proportional to Iᵢ, irrespective of a resistor R_{L}.

As described above, a power line communication system according to the present disclosure performs a current-type power line communication.

That is, when each individual equipment 20-1˜20-k sends information toward a power line, through the voltage/current conversion part 22 a voltage signal is converted and transmitted to a current signal, and when each individual equipment 20-1˜20-k receives information from the power line, through the current/voltage conversion part 23 a current signal is converted and transmitted to a voltage signal.

On the one hand, a constant current based power line communication system according to the present disclosure may be applied for an airfield lighting field, in this case, each individual equipment may include an individual lamp driver configured to control an airfield lighting lamp according to a lamp control command delivered on a power line communication.

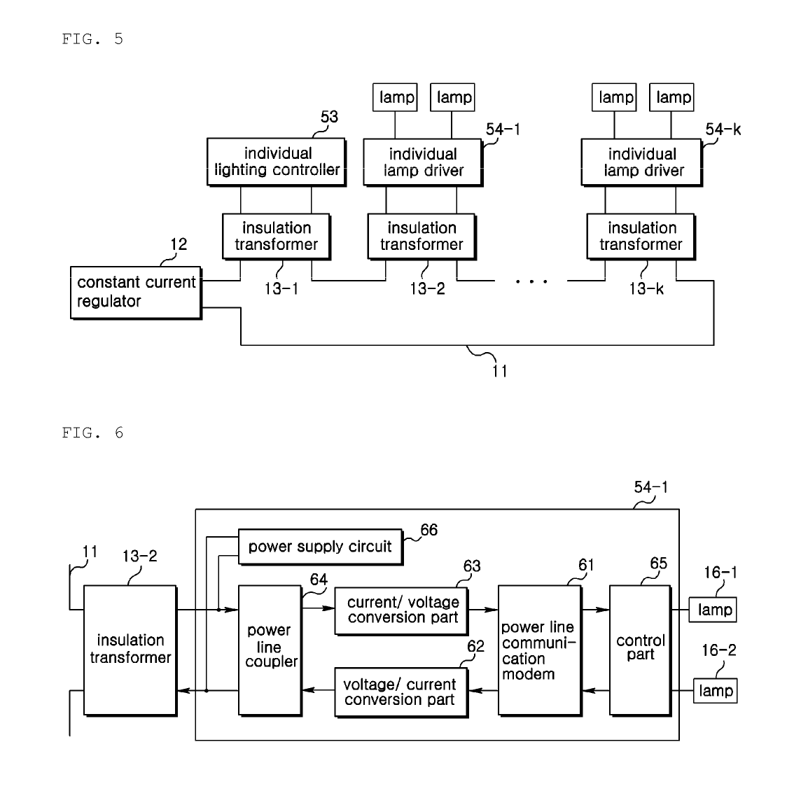

FIG. 5 is an example of a power line communication system for airfield lighting.

Referring to FIG. 5, a constant current regulator 12 supplies a constant current of maximum rated 6.6 A through a high-pressure cable (power line) constructing a single loop, wherein the power line 11 is connected to an individual lighting controller 53 and a multiple of individual lamp drivers 54-1˜54-k through insulation transformers 13-1˜13-k.

Insulation transformers 13-1˜13-k maintain an operating characteristic up to a power line communication frequency for power line communication.

An individual lighting controller 53 and each individual lamp driver 54-1˜54-k have a power line communication modem, and may include a power line coupler for alternating current interface with insulating transformers 13-1˜13-k. An individual lighting controller 53 makes a constant current regulator 12 on/off according to a command delivered from a main computer (not shown), and communicates with each individual lamp driver 54-1˜54-k using a power line communication.

Each individual lamp driver 54-1˜54-k determines on/off state of its self-managing lamp according to a lamp control command delivered by the individual lighting controller 53, and monitors a status of a lamp and reports up to the individual lighting controller 53.

A lamp of each individual lamp driver 54-1˜54-k may be on/off depending on whether the constant current regulator 12 supplies with a constant current, or adjusted with regard to the brightness.

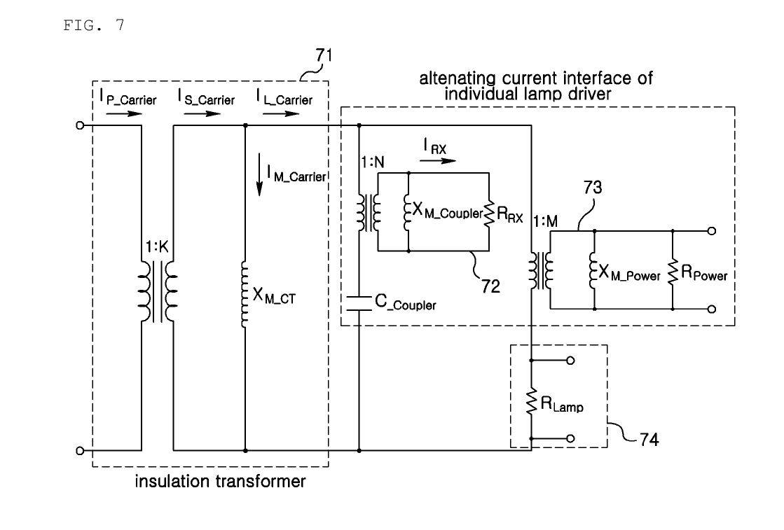

FIG. 6 is an embodiment of an individual lamp driver used in a power line communication system according to the present disclosure.

Referring to FIG. 6, an embodiment that the individual equipment in power line communication system for airfield lighting is an individual lamp driver will be described.

Each individual lamp driver 54-1 connects to a power line 11 through an insulation transformer 13-2, and includes, for operation, a power line communication modem 61, a voltage/current conversion part 62, a current/voltage conversion part 63, a power line coupler 64, a control part 65, and a power supply circuit 66.

A power line coupler 64 performs a coupling with an insulation transformer 13-2, and a power line communication signal of current form received from an insulation transformer is applied to the current/voltage conversion part 63, through the power line coupler 64, then converted to a voltage signal at the current/voltage conversion part 63, thus delivering to the power line communication modem 61.

Also, a power line communication signal of voltage form transmitted in a power line direction from the power line communication modem 61 is converted to a current signal at the voltage/current conversion part 62, then through the power line coupler 64 applied to an insulation transformer 13-2.

The power supply circuit 66 connected in parallel to the power line coupler 64, generates a power to be used in the individual lamp driver such as a lamp drive power or a drive power of a microprocessor from a constant current flowing onto the secondary side of an insulation transformer.

The control part 65 performs a power line communication through the power line communication modem 61 and controls airfield lighting lamps 16-1, 16-2.

The control part 65 may perform various functions as necessary, but basically controls lamps 16-1, 16-2 according to a lamp control command received from a power line side through the power line communication modem 61, also transmits status information of lamps 16-1, 16-2 through the power line communication modem 61 to the power line side.

While it is shown that one of the individual lamp drivers controls two lamps, it is obvious that the number of lamps controlled by each individual lamp driver may be variously constructed as necessary.

As such, each individual lamp driver performs a current-type power line communication by including the voltage/current conversion part 62 and the current/voltage conversion part 63, therefore there is no signal attenuation by voltage dividing like when using a voltage-type.

On the other hand, in order to minimize power dissipation accompanied by power line communication, the smaller secondary composite impedance of an insulation transformer is desirable.

FIG. 7 shows an equivalent circuit of an alternating-current interface of a individual lamp driver, in which I_{P}_{_{—}}_{Carrier} is a primary carrier current of an insulation transformer 71, I_{S}_{_{—}}_{Carrier} is a secondary carrier current of an insulation transformer 71, and I_{L}_{_{—}}_{Carrier} is a carrier load current.

At this time, the secondary composite impedance of the insulation transformer 71 can be expressed like the following Eq. 2.

$${Z}_{S \text{-} Carrier} = {X}_{M \text{-} CT} // [ \frac{1}{{N}^{2}} ( {X}_{M \text{-} Coupler} // {R}_{RX} ) + {X}_{C \text{-} Coupler} ] // [ \frac{1}{{M}^{2}} ( {X}_{M \text{-} Power} // {R}_{Power} ) + {R}_{Lamp} ] \qquad [ Equation 2 ]$$

where, X_{M-CT} means equivalent reactance of an insulation transformer 71, X_{M-Coupler} means equivalent reactance of a power-line coupler 72, and X_{M-Power} means equivalent reactance of an electric source circuit part 73, and R_{RX} means reception impedance of the power line communication modem, R_{power} is an equivalent impedance of the power supply circuit, and R_{Lamp} is an equivalent impedance of the lamp 74.

At this point, when

$$[ \frac{1}{{N}^{2}} ( {X}_{M \text{-} Coupler} // {R}_{RX} ) + {X}_{C \text{-} Coupler} ]$$

is minimized, it is possible to make a composite impedance smaller.

On the secondary side of an insulation transformer 71, a constant current of 60 Hz and a current signal for power line communication concurrently exist.

A constant current of 60 Hz does not possibly flow into the power-line coupler 72, and it needs to flow into a lamp 74 and an power supply circuit 73.

Thus, the power line coupler 72 may be connected in series to a capacitor C_{—coupler} for blocking a constant current of 60 Hz.

Also, so as to make a power-line communication current signal distributed toward the power supply circuit 73 and the lamp 74 smaller, it is desirable to maximize

$$[ \frac{1}{{M}^{2}} ( {X}_{M \text{-} Power} // {R}_{Power} ) ] .$$

The voltage/current conversion part and the current/voltage conversion part may be equipped in an individual lighting controller and each individual lamp driver.

Notably, the above-described embodiment has been described to help understanding of the present disclosure, however, it would be crystally clear that the disclosure is not limited to the above embodiment and can be practiced in a variously modified way by those skilled in the art without departing from the scope of the present disclosure.

What is claimed is:

1. In a constant current-based power line communication system in which a power line flowing with a constant current forms a closed loop, and the power line is connected in series with a plurality of individual equipment connected through an insulation transformer and operating using a constant current and a power line communication signal, the each individual equipment comprising:
a power line communication modem for transceiving a power line communication signal formed of a voltage signal; a voltage/current conversion part converting the power line communication signal formed of a voltage signal transmitted by the power line communication modem to a current signal and applying the current signal to the insulation transformer; and
a current/voltage conversion part converting a power line communication signal formed of a current signal received through the insulation transformer to a voltage signal, and delivering the voltage signal to the power line communication modem.

2. The system of claim 1, wherein the voltage/current conversion part is constructed to output a current signal in proportion to a pertinent voltage signal, when a voltage signal is applied to a non-inverting input terminal of an operational amplifier.

3. The system of claim 1, wherein the current/voltage conversion part is constructed to output a voltage signal in proportion to a pertinent current signal, when a current signal is applied to an inverting input terminal of an operational amplifier.

4. The system of claim 1, wherein the each individual equipment includes an individual lamp driver configured to control an airfield lighting lamp according to a lamp control command delivered via a power line communication signal.

5. The system of claim 4, wherein the individual lamp driver includes a power line coupler for coupling with a pertinent insulation transformer, a power supply circuit connected in parallel to the power line coupler, and generating a pre-determined power from a constant current flowing to a secondary side of the insulation transformer, and a control part operating by the power generated by the power supply circuit.

6. The system of claim 5, wherein the power line coupler is connected in series to a capacitor for blocking a constant current signal.
